(19) United States
(12) Patent Application Publication
(10) Pub. No.: US 2006/0169223 A1
(43) Pub. Date: Aug. 3, 2006

(54) Throttle device, fuel supply device, and engine

(75) Inventors: Shingo Tabata, Odawara (JP); Yasuhiro Tochigi, Odawara (JP)

Correspondence Address: STAAS & HALSEY LLP, SUITE 700, 1201 NEW YORK AVENUE, N.W., WASHINGTON, DC, 20005, US

(73) Assignee: MIKUNI CORPORATION, Tokyo (JP)

(21) Appl. No.: 11/338,629

(22) Filed: Jan. 25, 2006

(30) Foreign Application Priority Data
Feb. 1, 2005 (JP) 2005-025314

(51) Int. Cl. F02D 11/10; F01P 3/12

(52) U.S. Cl. 123/41.31; 123/399

(57) ABSTRACT

In a throttle device that includes a housing having an intake passage, a throttle valve to regulate the flow rate of the air flowing through the intake passage by rotation inside the intake passage, and a drive unit rotate the throttle valve, the drive unit is cooled with good efficiency. In a throttle device that includes a housing having an intake passage, a throttle valve to regulate the flow rate of the air flowing through the intake passage, and a drive unit to rotate the throttle valve, there is provided a cooling unit to directly cool the drive unit.

### CROSS-REFERENCE TO RELATED APPLICATIONS

This application claims priority benefit of Japanese Application No. 2005-025314, filed on Feb. 1, 2005, the disclosure of which is incorporated herein by reference.

### BACKGROUND OF THE INVENTION

1. Field of the Invention

The present invention relates to a throttle device, a fuel supply device, and an engine, and more particularly to a throttle device, a fuel supply device, and an engine which have cooling means for cooling a drive unit for rotating a throttle valve.

2. Description of the Related Art

A throttle device for regulating the air flow rate in an inlet passage is known which comprises a resin housing (throttle body) having the intake passage formed therein, a throttle valve (valve member) for regulating the channel surface area of the intake passage, a torque motor for rotating the throttle valve, and a metallic heat dissipating member installed in the intake passage of the housing so as to envelop the intake passage and also be in contact with the torque motor (for example, Japanese Patent Application Laid-open No. 11-132062).

However, in the above-described conventional throttle device, heat generated from the torque motor is transferred to the metallic heat dissipating member and dissipated via the heat-dissipating member into the air flowing in the intake passage, thereby ensuring that the torque motor is cooled. The resultant problem is that the heat transmission path is long, the length of the heat transmission path differs depending on the position of the torque motor (for example, zones of the torque motor that are far from the intake passage and close thereto), and cooling of the torque motor might be insufficient.

Another problem is that because the metallic heat dissipating member is provided at the resin housing, the structure of the throttle device is complex.

The same problems are also encountered in the throttle device in which a throttle valve is rotated by using a drive unit such as a DC motor.

### SUMMARY OF THE INVENTION

The present invention resolves the above-described problems and it is an object thereof to provide a throttle device comprising a housing having an intake passage, a throttle valve for regulating the flow rate of the air flowing through the intake passage by rotation inside the intake passage, and a drive unit for rotating the throttle valve, wherein the drive unit is cooled with good efficiency and the structure is simple, and also to provide a fuel supply device using such throttle device and an engine.

The invention of claim 1 provides a throttle device comprising a housing having an intake passage, a throttle valve for regulating the flow rate of air flowing through the intake passage by rotation inside the intake passage, and a drive unit for rotating the throttle valve, this throttle device having cooling means for directly cooling the drive unit.

The invention of claim 2 provides the throttle device according to claim 1, wherein the drive unit rotates the throttle valve by using a motor, and the housing is formed from a resin.

The invention of claim 3 provides the throttle device according to claim 2, wherein the cooling means cools the motor by causing part of the air flowing in the intake passage or part of the air that flowed in the intake passage to flow around the motor.

The invention of claim 4 provides the throttle device according to claim 2, wherein the cooling means cools the motor by causing cooling water to flow around the motor.

The invention of claim 5 provides the throttle device according to claim 2, wherein the cooling means cools the motor by using a heat dissipating member provided on the outer surface of the motor.

The invention of claim 6 provides a fuel supply device comprising the throttle device according to any one of claims 1 to 5, a surging tank provided downstream of the intake passage of the throttle device, a manifold provided downstream of the surge tank, and a fuel injection valve for injecting fuel into the manifold.

The invention of claim 7 provides an engine having the fuel supply device according to claim 6.

The effect of the present invention is that it can provide a throttle device with a simple structure which allows the drive unit to be cooled with good efficiency, a fuel supply device using the throttle device, and an engine.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating the external appearance of the throttle device of a first embodiment of the present invention.

FIG. 2 is a cross-sectional view along IIA-IIB in FIG. 1, illustrating schematically the throttle device structure.

FIG. 3 is a cross-sectional view along IIIA-IIIB in FIG. 1, illustrating schematically the throttle device structure.

FIG. 4 illustrates another arrangement of through orifices through which the cooling air flows for the throttle device structure corresponding to FIG. 3.

FIG. 5 illustrates another arrangement of through orifices through which the cooling air flows for the throttle device structure corresponding to FIG. 3.

FIG. 6 illustrates another arrangement of through orifices through which the cooling air flows for the throttle device structure corresponding to FIG. 3.

FIG. 7 illustrates a schematic configuration of the cooling means of the throttle device of a second embodiment of the present invention.

FIG. 8 illustrates another mode relating to the case of cooling the DC motor by using cooling water for the throttle device corresponding to FIG. 7.

FIG. 9 illustrates another mode relating to the case of cooling the DC motor by using cooling water for the throttle device corresponding to FIG. 7.

### DETAILED DESCRIPTION OF THE PREFERRED EMBODIMENTS

The embodiments of the present invention are explained below with reference to the drawings.

### FIRST EMBODIMENT

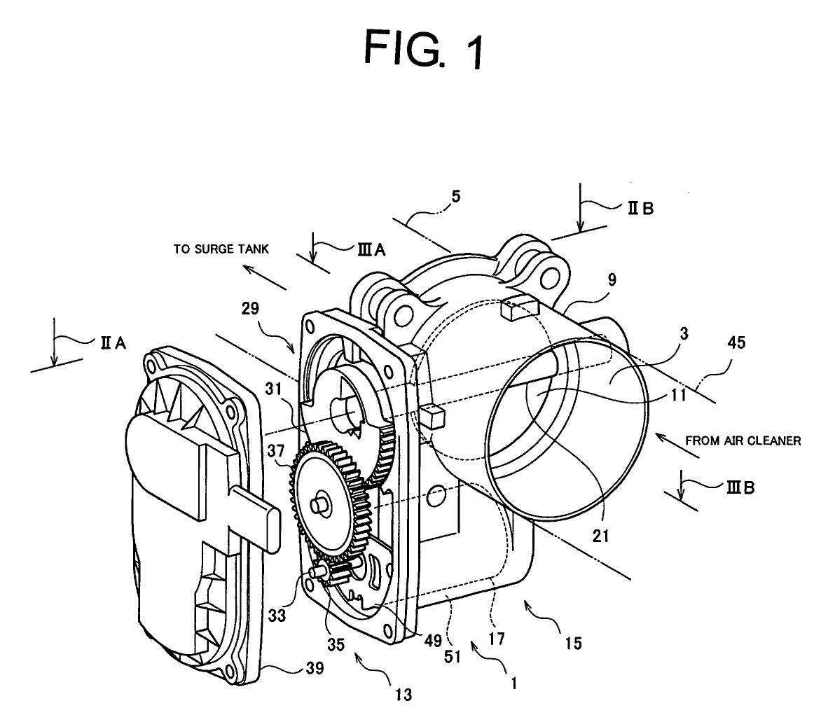

FIG. 1 is a perspective view illustrating the external appearance of the throttle device 1 of a first embodiment of the present invention.

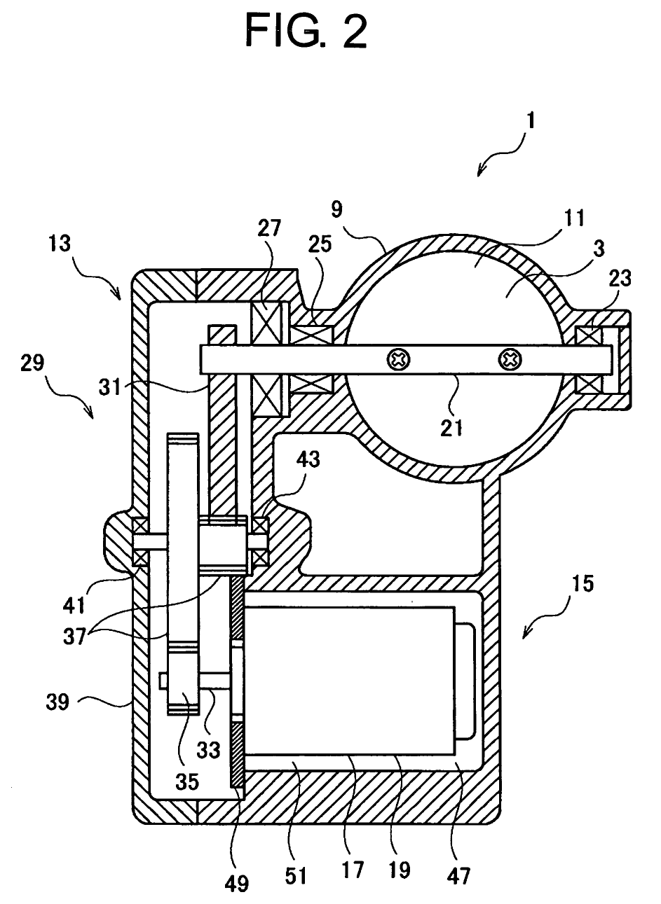

FIG. 2 is a cross-sectional view along IIA-IIB in FIG. 1; this view illustrates schematically the configuration of the throttle device 1.

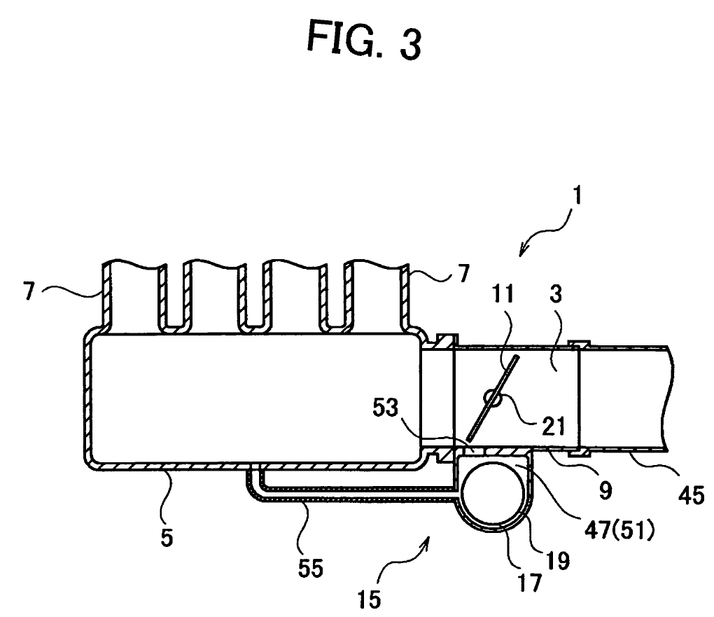

FIG. 3 is a cross-sectional view along IIIA-IIIB in FIG. 1; this view illustrates schematically the configuration of the throttle device 1.

The throttle device 1, as shown in FIG. 3, constitutes a fuel supply device for an engine, such as a four-cycle engine, by comprising a surge tank 5 provided downstream of an intake passage 3 of the throttle device 1, a manifold 7 provided downstream of the surge tank 5, and a fuel injection valve (not shown in the figures) for injecting an appropriate fuel into the manifold 7 under the control of a control unit (ECU; Electronic Control Unit) which is not shown in the figure.

The throttle device 1 comprises a housing 9 (see FIG. 2) comprising the intake passage 3 which has a round cross-sectional shape in a plane perpendicular to the longitudinal direction, a disk-like throttle valve 11 for regulating the flow rate of air flowing in the intake passage 3 by changing the channel surface area of the intake passage 3 by rotating inside the intake passage 3 with respect to the housing 9, and a drive unit 13 for rotating the throttle device 11.

Furthermore, the throttle device 1 is also provided with cooling means 15 for directly cooling the drive unit 13 by using a fluid.

The drive unit 13, as mentioned hereinabove, serves to rotate the throttle valve 11 by using a motor (for example, a DC motor) 17. The housing 9 is formed from a resin such as PPS (polyphenylene sulfide), PEI (polyetherimide), PEEK (polyether ether ketone), PTFE (polytetrafluoroethylene),

The cooling means 15 cools the drive unit 13 by forcibly directing a fluid such as air onto the outer surface of an actuator (outer surface of the actuator case; outer surface of the case 19 of the DC motor 17), which is the main heat generation source of the drive unit 13. For example, part of the air flowing through the intake passage 3 or part of the air that flowed through the intake passage 3 flows around the DC motor 17, thereby cooling the DC motor 17.

More specifically, as shown in FIG. 2, the throttle valve 11 is provided integrally with a rod-like shaft 21. The shaft 21 is provided inside the intake passage 3 along the diameter of the intake passage 3 and is supported by the housing 9, for example, via bearings 23, 25 at both ends thereof. As a result, the shaft is free to rotate with respect to the housing 9.

When the shaft 21 rotates, the throttle valve 11 rotates through an almost 90° angle, and the opening degree of the intake passage 3 can be regulated between an almost completely closed state and a completely opened state.

A return spring 27 comprising, for example, a twisted coil spring, is provided between the shaft 21 and the housing 9.

One end side of the shaft 21 slightly protrudes from a wall (thin section constituting the wall) of the housing 9 forming the intake passage 3, and a gear 31 constituting power transmission means 29 is integrally provided on the protruding section.

The DC motor 17 (case 19 of the DC motor 17) is provided integrally with the housing 9. A gear 35 constituting the power transmission means 29 is integrally provided on a rotary output shaft 33 of the DC motor 17. An intermediate gear 37 constituting the power transmission means 29 is provided between the gear 31 provided on the shaft 21 and the gear 35 provided on the DC motor 17, and the rotation of the rotary output shaft 33 of the DC motor 17 is transmitted to the shaft 21.

A throttle position sensor (not shown in the figure) that can detect the rotation quantity of the shaft 21 (throttle valve 11) is provided on one end portion of the shaft 21.

If the DC motor 17 is rotated under the control of the control unit (ECU) correspondingly to the displacement of the accelerator control pedal (not shown in the figure) or the detected value of the throttle position sensor, the throttle valve 11 rotates and the intake passage 3 is appropriately opened or closed, despite the impelling force of the return spring 27.

The side of the housing 9 where the gears 31, 35, and 37 are provided is covered and closed with a cover member 39. One end section of the intermediate gear 37 is supported via a bearing 41 on the cover member 39, and the other end section thereof is rotatably supported via a bearing 43 on the housing 9.

An air duct 45 is provided, as shown in FIG. 3, on the upstream side of the intake passage 3, and an air cleaner (not shown in the figure) is provided further upstream of the air duct 45. On the other hand, the aforementioned surge tank 5 is provided downstream of the intake passage 3, and a manifold 7 is provided downstream of the surge tank 5. The manifold 7 is connected to a combustion chamber of the engine. Furthermore, the aforementioned fuel injection valve (not shown in the figure) for injecting the fuel supplied to the engine into the manifold under the control of the control unit is provided in the manifold 7.

The air that passed through the air cleaner, air duct 45, intake passage 3, surge tank 5, and manifold 7 and the fuel injected by the fuel injection valve are supplied to the engine.

The arrangement and cooling method of the DC motor 17 will be described below in greater detail.

A space (concave section; a space with an inner diameter slightly larger than the outer diameter of the case 19 of the DC motor 17 and with a depth slightly larger than the length of the case 19 of the DC motor 17) 47 for accommodating the DC motor 17 is provided in the housing 9, and the flange member 49 integrally provided on the case 19 of the DC motor 17 is fixed to the housing 9. As a result, the case 19 of the DC motor 17 is provided integrally with the housing 9 and accommodated in the space 47. Furthermore, a cylindrical gap 51 is formed between the case 19 of the DC motor 17 and the inner wall of the space 47.

Further, as shown in FIG. 3 through FIG. 6, there are provided a first small-diameter through orifice 53 (53A, 53B, 53C) for linking the gap 51 with a zone (including the air duct and the like) located upstream of the intake passage 3 or a zone (including the surge tank or manifold) located downstream of the intake passage 3, and a second small-diameter through orifice 55 for linking the zones (may be the zone upstream the intake passage 3 and the gap 51) located downstream of the intake passage 3. Because those orifices are provided, the DC motor 17 is directly cooled by using part of the air flowing through the intake passage 3 or part of the air that flowed through the intake passage 3.

Those through orifices 53, 55 will be described below in greater detail by reference to FIG. 3.

The first through orifice 53 is provided in the housing 9 (section of the wall forming the intake passage 3). This through orifice links the gap 51 with the zone of the intake passage 3 that is located slightly downstream of the zone where the throttle valve 11 is provided.

The second through orifice 55 links together the gap 51 and the surge tank 5 provided downstream of the intake passage 3, for example, by using a pipe.

The open section of the first through orifice 53 on the side of the gap 51 and the open section of the second through orifice 55 on the side of the gap 51 are provided in positions facing each other via the case 19 of the DC motor 17.

Providing such through orifices 53, 55 enables the air to flow with good efficiency in the gap 51 and makes it possible to cool the DC motor 17 directly during engine operation.

The air flowing in the through orifices 53, 55 and gap 51 will be described below in greater detail. The flow velocity of the air in the vicinity of the open section of the first through orifice 53 on the side of the intake passage 3 (in the vicinity of the open section of the first through orifice) becomes higher than the flow velocity of the air in the vicinity of the open section of the second through orifice 55 on the side of the surge tank 5 (in the vicinity of the open section of the second through orifice). As a result, the air pressure in the vicinity of the open section of the first through orifice becomes lower than the air pressure in the vicinity of the open section of the second through orifice, part of the air located inside the surge tank 5 enters the gap 51 from the second through orifice 55, and the air that entered the gap is discharged into the intake passage 3 through the first through orifice 53.

At this time, the air flowing in the gap 51 generates forced convection around the case 19 of the DC case 17, the DC motor 17 is directly cooled, and the increase in temperature of the DC motor 17 can be prevented.

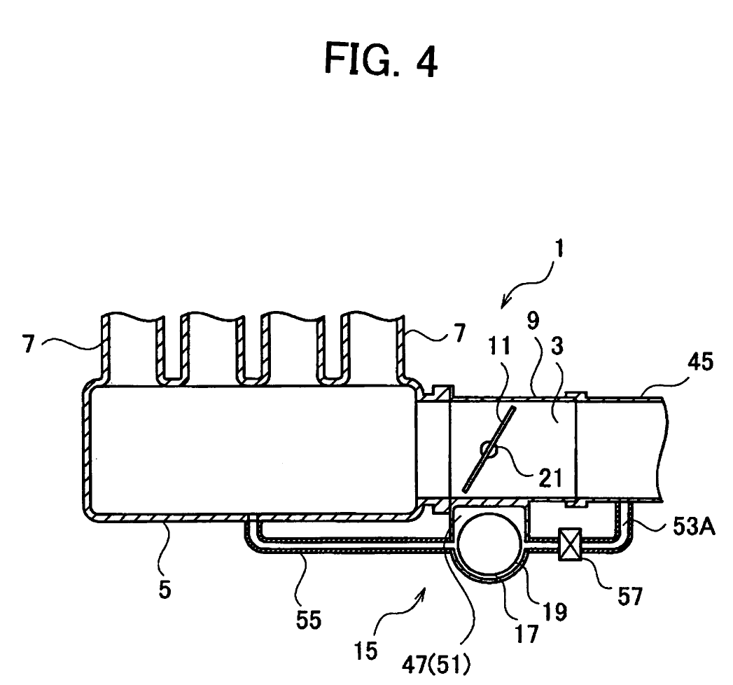

As shown in FIG. 4 (the figure illustrating another arrangement of through orifices for passing the cooling air; corresponds to FIG. 3), it is also possible to leave the second through orifice 55 as is, to change the disposition of the first through orifice 53, and to link together the gap 51 and the zone of the intake passage 3 that is located upstream of the zone where the throttle valve 11 is provided (for example, the intake passage inside the air duct 45) by using the first through orifice 53A.

When the first through orifice 53A is thus provided, if the engine is operated, the air pressure in the vicinity of the open section of the first through orifice 53A on the side of the intake passage 3 becomes higher than the air pressure in the vicinity of the open section of the second through orifice 55 on the side of the surge tank 5. Therefore, part of the air located upstream of the throttle valve 11 enters the gap 51 from the first through orifice 53A, and this air cools the DC motor 17 and is discharged into the surge tank 5 via the second through orifice 55.

It is preferred that a diaphragm 57 be provided in the first through orifice 53A in order to prevent a large amount of air from flowing from inside the air duct 45 (upstream of the throttle valve 11) into the surge tank 5. The diaphragm 57 may be also provided in the second through orifice 55.

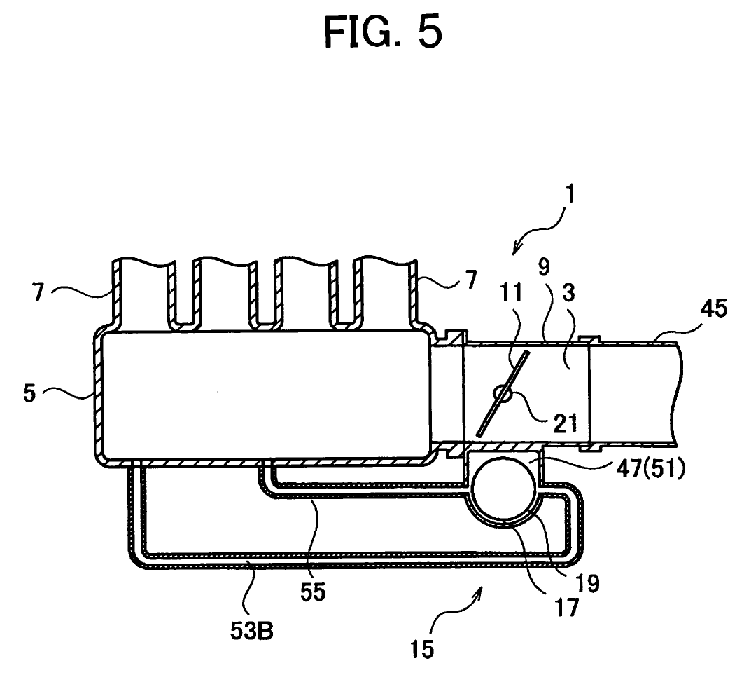

Furthermore, as shown in FIG. 5 (the figure illustrating another arrangement of through orifices for passing the cooling air; corresponds to FIG. 3), it is also possible to leave the second through orifice 55 as is, to change the disposition of the first through orifice 53, and to link together the gap 51 and the surge tank 5 by using the first through orifice 53B. In this case, the open section of the first through orifice 53B (open section on the side of the surge tank 5) is formed in a location at a distance from the location where the open section of the second through orifice 55 is provided (open section on the side of the surge tank 5).

Thus, for example, the open section of the first through orifice 53B and the open section of the second through orifice 55 are so provided that the air pressure in the vicinity of the open section of the first through orifice 53B (open section on the side of the surge tank 5) and the air pressure in the vicinity of the open section of the second through orifice 55 (open section on the side of the surge tank 5) are different when the engine is operated.

Because the through orifices 53B, 55 are thus provided, when the engine is operated, part of the air located in the surge tank 5 enters the gap 51 via one through orifice of the through orifices 53B, 55 and the air that entered the gas cools the DC motor 17 and is discharged into the surge tank 5 via the other through orifice of the through orifices 53B, 55.

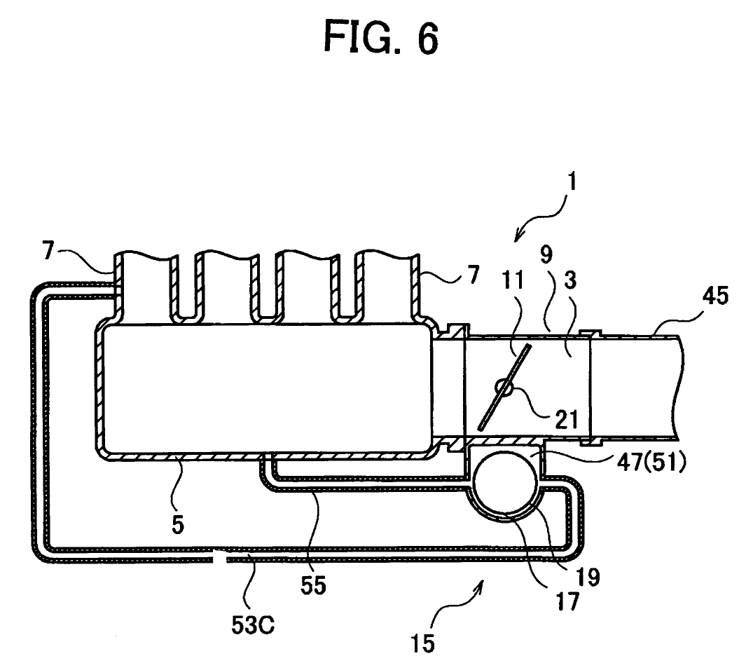

Furthermore, as shown in FIG. 6 (the figure illustrating another arrangement of through orifices for passing the cooling air; corresponds to FIG. 3), it is also possible to leave the second through orifice 55 as is, to change the disposition of the first through orifice 53, and to link together the gap 51 and the manifold 7 by using the first through orifice 53C.

When the first through orifice 53C is thus provided, if the engine is operated, the air pressure in the vicinity of the open section of the first through orifice 53C on the side of the manifold 7 becomes lower than the air pressure in the vicinity of the open section of the second through orifice 55 on the side of the surge tank 5. Therefore, part of the air located in the surge tank 5 enters the gap 51 from the second through orifice 55 and the air that entered the gap cools the DC motor 17 and is discharged into the manifold 7 via the first through orifice 53C.

It is preferred that a diaphragm be provided in the first through orifice 53C in order to prevent a large amount of air from flowing from inside the surge tank 5 to the manifold 7. The diaphragm may be also provided in the second through orifice 55.

With the throttle device 1, because cooling means 15 is provided for directly cooling the drive device 13, the drive device 13 can be cooled with good efficiency. Moreover, because heat dissipating members are not required for cooling the motor by thermal conductivity, as in the conventional configuration, the structure of the throttle device 1 can be simplified.

Furthermore, because the housing 9 of the throttle device 1 is made from a resin, the process for manufacturing the housing 9 can be simplified. Thus, when the housing is formed by casting a metal such as aluminum, the housing has to be subjected to machining (cutting, etc.) to increase the shape precision thereof because of a casting draft or the like, whereas if the housing 9 is manufactured from a resin, for example, by molding, the housing 9 can be molded with good accuracy. Therefore, if the housing 9 is made from resin, machining after molding is unnecessary and the manufacturing process can be simplified.

Furthermore, with the throttle device 1, an inexpensive DC motor 17 is used as a drive device of the throttle valve 11. Therefore, the production cost of the throttle device 1 can be reduced.

Furthermore, after the rotation of the throttle valve 11 has been stopped by opening the throttle valve 11, the rotation of the DC motor 17 stops, but the DC motor 17 has to continue generating the same torque as the impelling force (impelling torque) of the return spring 27 provided at the throttle valve 11.

Therefore, a large electric current flow through the DC motor 17 and the DC motor 17 easily generates heat. However, because part of the air that flows in the intake passage 3 or part of the air that flowed in the intake passage 3 flows around the DC motor 17 and the DC motor 17 is cooled by forced convection of the air. Therefore, the DC motor 17 can be cooled by the cooling means 15 with good efficiency. Therefore, even though the inexpensive DC motor 17 is used, the temperature of the DC motor 17 is prevented from rising and making the motor impossible to use.

### SECOND EMBODIMENT

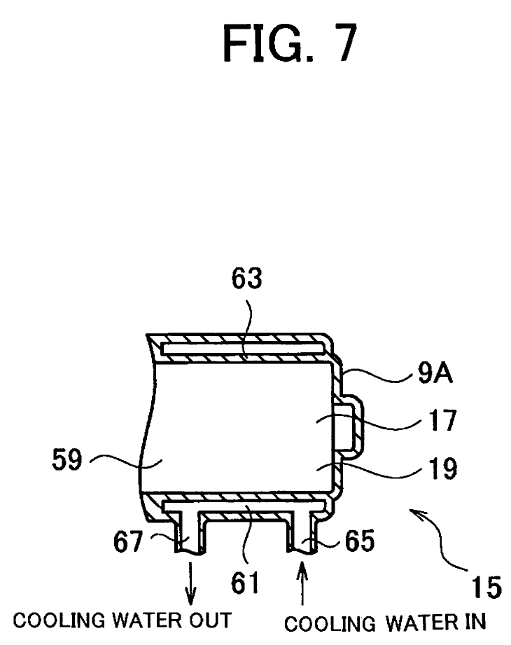

FIG. 7 shows a schematic configuration of the cooling means 15 of the throttle device of a second embodiment of the present invention.

The throttle device of the second embodiment differs from the throttle device 1 of the first embodiment in that the DC motor 17 is cooled by using a liquid, such as cooling water. In other aspects, it is configured almost identically to the throttle device 1 of the first embodiment and demonstrates almost the same effect.

Thus, the cooling means 15 of the throttle device of the second embodiment cools the DC motor 17 by causing the cooling water of the engine to flow around the DC motor 17.

More specifically, a columnar space (a space with an inner diameter almost equal to the outer diameter of the case 19 of the DC motor 17) 59 for accommodating the DC motor 17 is formed in the housing 9A of the throttle device of the second embodiment, and the DC motor 17 is disposed inside the space 59. As a result, the case (for example, a case having the outer surface formed to have a columnar shape) 19 of the DC motor 17 is accommodated inside the space. In a state in which the case 19 of the DC motor 17 was accommodated inside the case 59, the inner wall of the space 59 is in contact with the outer wall of the DC motor 17.

Furthermore, a tubular (for example, in the form of a round tube) closed space 61 is formed on the outer side of the space 59 so as to surround the space 59. In other words, the space 59 where the DC motor 17 is accommodated is enclosed in a closed space 61 via a tubular (for example, in the form of a round tube) zone (tubular zone formed by the body of the housing 9A) 63.

Furthermore, a cooling water supply opening 65 for introducing cooling water (for example, cooling water of an engine) into the closed space 61 and a cooling water discharge opening 67 for discharging the cooling water from the closed space are provided in the closed space 61.

Furthermore, when the engine operates, the cooling water is supplied into the closed space 61 by a cooling water circulation pump (not shown in the figure), heat generated by the DC motor 17 is absorbed by the cooling water, and the cooling water warmed up by the DC motor 17 is discharged.

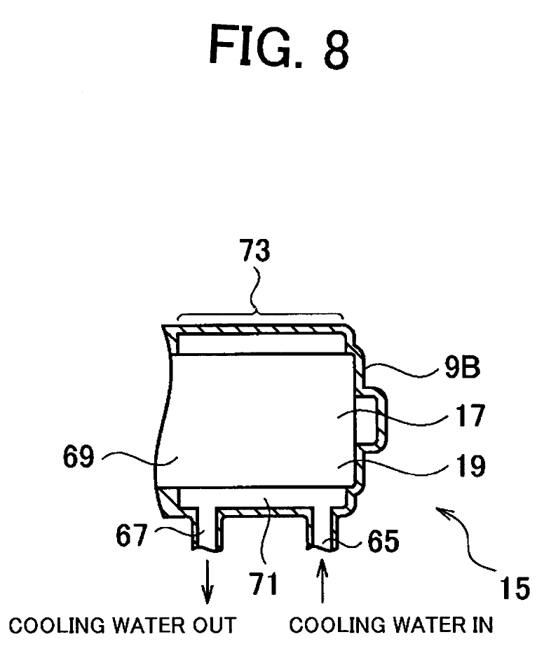

In the configuration shown in FIG. 7, the closed space 61 is formed integrally with the housing 9A, in other words, the closed space 61 is formed in the body of the housing 9A, but as shown in FIG. 8 (the figure illustrating another mode of cooling the DC motor with cooling water; corresponds to FIG. 7), closed space 71 may be formed by the case 19 of the DC motor 17 and housing 9B when the DC motor 17 is accommodated in the space 69.

More specifically, the tubular closed space 71 may be formed when the DC motor 17 is accommodated in columnar space 69 because the inner diameter of both end sections in the axial direction of the columnar space 69 accommodating the DC motor 17 is almost equal to the outer diameter of the case 19 of the DC motor 17, and the inner diameter of intermediate section 73 in the axial direction of the columnar space 69 is slightly larger than the outer diameter of the case 19 of the DC motor 17.

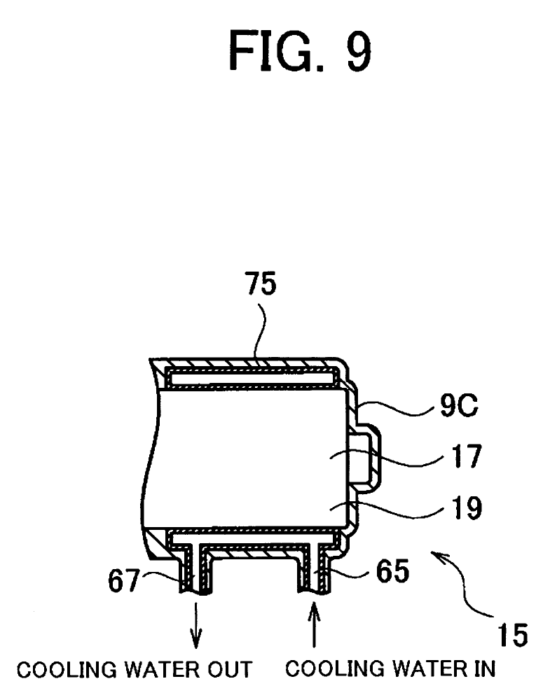

Furthermore, as shown in FIG. 9 (the figure illustrating another mode of cooling the DC motor with cooling water; corresponds to FIG. 7), the DC motor 17 may be cooled by using water jacket 75.

More specifically, the space of housing 9C accommodating the DC motor 17 is formed to have a shape almost identical to that of the space 69 shown in FIG. 8. Furthermore, the water jacket 75 is composed of a member other than the housing 9C. Moreover the water jacket 75 is formed to have a tubular (for example, cylindrical) outer shape. The outer diameter of the tubular water jacket 75 is almost equal to the inner diameter of the inner space (zone where the diameter is increased) of the housing 9C, and the inner diameter of the water jacket is almost equal to the outer diameter of the DC motor 17.

If the water jacket 75 and DC motor 17 are disposed in the space of the housing 9C, the inner wall (inner wall of the intermediate section in the axial direction) of the space of the housing 9C and the outer peripheral section of the water jacket 75 are brought into contact with each other, and the inner peripheral section of the water jacket 75 and the outer surface of the case 19 of the DC motor 17 are brought into contact with each other.

A tubular closed space (for example, a cylindrical closed space) is formed inside the water jacket 75, and a cooling water supply opening 65 for introducing the cooling water into the closed space and a cooling water discharge opening 67 for discharging the cooling water from the closed space are provided in the tubular closed space.

The DC motor 17 is cooled by causing the cooling water to flow in the tubular closed space, in the same manner as shown in FIG. 7.

With the throttle device of the second embodiment, the DC motor 17 is cooled by causing the cooling water to flow around the DC motor 17. Therefore, the DC motor 17 can be cooled with even better efficiency than in the case where air was used.

### THIRD EMBODIMENT

The throttle device of a third embodiment differs from the throttle device 1 of the first embodiment in that the DC motor 17 is air cooled by using a heat dissipating member, but in other aspects it is configured and used almost identically to the throttle device 1 of the first embodiment and demonstrates almost identical effect.

More specifically, the case of the DC motor is directly exposed to the external air, without providing a closed space for accommodating the DC motor in the housing 3 and a multiplicity of heat dissipating members (heat dissipating members exposed to the external air) such as heat sink plates are provided at the case of the DC motor to cool the DC motor.

More specifically, the case of the DC motor is directly exposed to the external air, without providing a closed space for accommodating the DC motor in the housing 3 and a multiplicity of heat dissipating members (heat dissipating members exposed to the external air) such as heat sink plates are provided at the case of the DC motor to cool the DC motor.

With the throttle device of the third embodiment, the DC motor is cooled by using heat dissipating members provided on the outer surface of the DC motor, without using the air flowing in the intake passage. Therefore, the increase in temperature of the air flowing in the intake passage can be inhibited.

Furthermore, in the above-described embodiments, the explanation was conducted with respect to the throttle device in which the throttle valve was rotated by using the DC motor, but the above-described embodiments can be also applied to throttle devices in which throttle valves are rotated by using an actuator (for example, a torque motor) other than the DC motor.

The torque motor is, for example, a motor described in Japanese Patent Application Laid-open Publication No. 11-132062 and comprises a case, a rotor, a stator core, and a solenoid. In this rotor, a rotary output shaft formed integrally with the rotor is rotated within an angular range of, for example, 90°, while generating a large torque, by controlling the electric current flowing in the solenoid. The motor can be used by directly connecting the rotary output shaft to the shaft integrally supporting the throttle valve.

Furthermore, in the above-described embodiments, the explanation was conducted by using air flowing in the intake passage or cooling water for cooling an agent as the cooling means. However, the present invention is not limited to this cooling means. For example, the drive unit can be directly cooled by using an engine oil or a coolant gas for air conditioners.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A throttle device comprising:
a housing having an intake passage;
a throttle valve to regulate the flow rate of air flowing through said intake passage by rotation inside said intake passage;
a drive unit to rotate said throttle valve; and
cooling means for directly cooling said drive unit.

2. The throttle device according to claim 1, wherein
said drive unit rotates said throttle valve by using a motor, and
said housing is formed from a resin.

3. The throttle device according to claim 2, wherein
said cooling means cools said motor by causing part of the air flowing in said intake passage or part of the air that flowed in said intake passage to flow around said motor.

4. The throttle device according to claim 2, wherein
said cooling means cools said motor by causing cooling water to flow around said motor.

5. The throttle device according to claim 2, wherein
said cooling means cools said motor by using a heat dissipating member provided on the outer surface of said motor.

6. A fuel supply device comprising:
the throttle device according to any one of claims 1 through 5;
a surging tank provided downstream of the intake passage of said throttle device;
a manifold provided downstream of said surge tank; and
a fuel injection valve to inject fuel into said manifold.

7. An engine having the fuel supply device according to claim 6.
